(19) United States
(12) Patent Application Publication
(10) Pub. No.: US 2008/0206606 A1
(43) Pub. Date: Aug. 28, 2008

(54) Cathode For a Large-Surface Fuel Cell

(76) Inventors: Jose Manuel Serra Alfaro, Valencia (ES); Sevn Uhlenbruck, Pulheim (DE); Hans-Peter Buchkremer, Heinsberg (DE); Detlev Stoever, Niederzier (DE)

Correspondence Address: JORDAN AND HAMBURG LLP, 122 EAST 42ND STREET, SUITE 4000, NEW YORK, NY, 10168, US

(21) Appl. No.: 11/919,614

(22) PCT Filed: Apr. 27, 2006
(86) PCT No.: PCT/DE2006/000734

§ 371 Date: Dec. 20, 2007

(30) Foreign Application Priority Data
May 13, 2005 (DE) 10 2005 023 048.2

(51) Int. Cl. H01M 4/00

(52) U.S. Cl. 429/12; 427/77

(57) ABSTRACT

A cathode for high-temperature fuel cell, comprising a layer of porous particles applied on a sintered electrolyte, the layer having a surface area of 15 to 900 m² per gram and the average size of the porous particles do not exceed 30 nm and a method for preparing the same.

The invention relates to a cathode for a high-temperature fuel cell as well as to a fuel cell with a cathode.

Fuel cells are able to convert chemical energy of fuels, such as hydrogen, directly into electrical energy. In comparison to generating power by methods, for which fuels are burned, clearly better efficiencies are therefore possible. The efficiency of a fuel cell may be twice as high as that of a conventional combustion power plant. Moreover, power generation with a fuel cell is particularly nonpolluting. Fuels can be used flexibly. Fuel cells are known, for example, from the DE 100 33 898 A1 as well as from the DE 100 61 375 A1.

Fuel cells have very different constructions and are operated at very different temperatures. Correspondingly, fuel cells have different names. A fuel cell, which is operated at very high temperatures of several 100° C., is referred to as a high-temperature fuel cell. The operating temperature of a high-temperature fuel cell usually is between 600° and 950° C.

A fuel cell comprises an electrolyte layer, adjoining which there is, on the one side, an anode and, on the other, a cathode. The cathode has the task of converting gaseous oxygen into oxide ions and to make the transport to the electrolyte possible. In order to make the transport of oxygen through the cathode possible, the latter is porous and, moreover, in such a manner, that gas can be passed through the cathode. Such an open-pored cathode for high-temperature fuel cells is described in the DE 102 088 82 A1. The porous structure results in an enlargement of the surface area and such an enlargement is an advantage for a high conversion of gas.

The porous cathodes for high-temperature fuel cells, known from the prior art, consist of dense particles with an average particle diameter of more than 400 nm. This results in a surface area for the cathode of less than 5 m² per gram of cathode material. The cathode of a high-temperature fuel cell comprises Perovskite-like composite materials such as LaₓSr_{y}MnO_{3-δ} and LaₓSr_{y}Fe_{1-z}Co_{z}O_{3-δ} or composites, which comprise, aside from Perovskite-like materials, also fluoride-like materials such as YₓZr_{1-y}O₂_{^{—}}_{δ} and CeₓGd₁₋ₓO₂_{^{—δ}}. Suitable materials are described in the DE 102 088 82 A2.

High-temperature fuel cells have two particularly important disadvantages:
The high operating temperatures requires the use of materials, which have a correspondingly high temperature resistance. This leads to high material costs and a short operating life of such a fuel cell. The high operating temperatures make the mobile use such a fuel cell, for example, in a motor vehicle, or in the private area difficult.
The energy density is comparatively low.

It is an object of the invention to make a more efficient high-temperature fuel cell possible.

Due to the invention, cathodes with a distinctly larger active surface area can be produced. The attainable cathode surface areas are of the order of 15 to 900 m² per gram of cathode material and, with that, very clearly exceed the surface areas of the prior art. Since the active surface area of a high-temperature fuel cell at the present time limits the performance, an increase in the active surface area results in a corresponding increase in the performance of a fuel cell.

Due to the selection of a starting powder with a small diameter for producing the cathode and by generating pores in the powder, cathodes having large surface areas can be achieved. Pursuant to the invention, pores in the powder are produced by fillers, which are removed from the powder at the appropriate time.

Pursuant to the method, a starting point is soluble salts of different metals, a solvent and a filler. In one embodiment, sufficiently small carbon particles are selected as fillers, since these can be removed easily by combustion at the appropriate time. The starting materials are mixed suitably. If the soluble salts have dissociated, mixtures of hydroxide and oxide particles are produced, which contain the filler or fillers. Subsequently, the fillers are removed, for example, by combustion. For this purpose, the hydroxide and oxide particles are treated thermally, for example, by being calcined for a few hours. The resulting metal oxide powder is porous and forms the starting material for producing the cathode.

Optionally, a plasticizer may be provided additionally as starting material. This improves the viscosity during the mixing and homogenizing. Agglomerations between the carbon particles are thus avoided. This has a positive effect on the final porosity.

Electrochemical processes, which take place in a cathode, limit the performance of a high-temperature fuel cell. These are, above all, processes, which depend on the surface area of the catalytically active material of a cathode, such as oxygen diffusion, oxygen dissociation, oxygen reduction and ion conductivity of the surface. Pursuant to the invention, it is possible to produce a cathode with a clearly larger active surface area, so that a fuel cell, produced with such a cathode, also has a clearly better efficiency.

In an advantageous embodiment of the invention, porous powders with an average diameter of 1 to 30 nm are produced in order to attain cathodes with a surface area of 15 to 400 m²/gram. Salts with metallic components are mixed together with carbon particles, preferably carbon black, in a solvent. In particular, the salts also comprise nitrates and dissolve in the solvent. The carbon particles are selected so that preferably they have an average diameter of 3 to 25 nm.

The mixture is homogenized, for example, by mechanical stirring or by an ultrasonic treatment, treated thermally and dried. The salts are decomposed thermally and the carbon, now present in the powders formed, is combusted, for example, at temperatures between 150° and 850° C. in an oxygen-containing gas such as air, oxygen, ozone and/or N₂O. The powder is applied on a sintered electrolyte layer, for example, by screen printing, by a wet powder spraying method, by coating methods such as dip coating or spin coating (=a method of preparation, for which the material of the layer is applied on a very rapidly rotating substrate), by tape casting methods, by vapor deposition or by a combination of the above methods. A cathode with a surface area of 15 to 400 m² per gram is produced by a thermal treatment at 650° C. to 1200° C. in an oxygen-containing atmosphere. The average size of the pores, which are distributed evenly, typically is then 1 to 30 nm. The structure is an open pored one. In particular, the pores contribute to more than 70% of the surface area of the cathode.

In a different embodiment of the invention, salts with metallic components are mixed together with a surface active material in a solvent. The salts then comprise above all halides and dissolve in the solvent.

The mixture is a homogenized and treated thermally and dried. A precipitation is carried out by adding a basic solution. Next, the product is treated thermally at temperatures between −15° C. and 100° C. and subsequently at temperatures of 75° C. to 250° C. The solid particles are separated from the remaining liquid, for example, by filtration, sedimentation, centrifugation or a combination of these methods. The organic components in the powder, so formed, are combusted, for example, at temperatures between 150° and 850° C. in an oxygen-containing gas such as air, oxygen, ozone and/or N₂O. The powder is applied on a sintered electrolyte layer, for example, by screen printing, by a wet powder spraying method, by coating methods such as dip coating or spin coating, by tape casting methods, by vapor deposition or by a combination of the above methods. A cathode with a surface area of 30 to 900 m² per gram is produced by a thermal treatment at 650° C. to 1200° C. in an oxygen-containing atmosphere. The average size of the pores of the cathode, which are distributed evenly, typically is then 5 to 80 Å. The size of the pores may be distributed unimodally or bimodally. In particular, the pores contribute to more than 80% of the surface area of the cathode.

Water or ethanol is particularly suitable as solvent. However, other solvents, such as alcohols and polyalcohols, ethers, ketones, alkanes, alkenes and mixtures of solvents also come into consideration. In one embodiment of the invention, the salts contain nitrate, halide, sulfate, acetate, oxalate, alkoxide, acetylacetonate, hydroxide, citrate or combinations thereof.

Suitable as surface active material are, for example, polyoxyethylene alkyl ether, polyoxyethylene polyoxypropylene tri-block copolymer, an alkyl ammonium salt with a molecular weight of more than 100 D or an organic amine. As basic component for the precipitation reaction, alkali metal hydroxide, alkaline earth metal hydroxide, alkali metal carbonate, ammonia, urea, purine, pyrimidine, analine or combinations thereof come into consideration.

A cathode, produced pursuant to the invention, may be produced from the following particles or may comprise these particles:
cerium oxide doped with Gd, Sm, Pr, Nd, Er, Yb and/or Dy and/or
zirconium oxide doped with Y, Sc, Ca, Mg, Al, Er, Yb, Gd and/or with elements from the series Eu to Dy and/or
mixed oxides with La, Sr, Mn, Fe, Co, Cr, Pr, Ba, Ca, Ni, Cu, Ti, Y or elements from the series Zr to Ce.

Such a cathode may have a Perovskite structure, a calcium fluoride structure, a pyrochloride structure, a Runddiesden-Popper oxide structure or a bronze structure and be provided with noble metals, such as Pt, Pd, Rh, Au, Ru, Re, Ag, Ir or a combination thereof. The proportion of noble metals in the cathode preferably is 0.1 to 2.5% by weight.

The salts preferably comprise cerium. In one embodiment, particularly a cerium nitrate is used as the salt starting material. Pursuant to the invention, a cathode then results, which is based on CeO₂. Preferably, this is doped with at least one rare earth element. The material has a fluorite structure and is strictly an ion conductor at the operating temperatures existing in a high-temperature fuel cell. The doping material advantageously increases the desired ironic conductivity and advantageously stabilizes the cubic fluorite structure. Overall, a cathode is produced in this manner, which is able to transport oxygen ions particularly well.

An additional doping of the ZrO₂ with a different, second element such as La, Sr, Mn, Fe, Co, Cr, Pr, Ba, Ca, Ni, Cu, Ti, Y, Zr to Ce also further improves the transport of oxygen ions and, with that, the performance of the fuel cell.

In an embodiment of the invention, a Perovskite structure ABO₃ of the cathode is preferred, in order to arrive at a particularly good catalytic activity for the reduction of the oxygen and a particularly good electronic conductivity, ion conductivity as well as thermal stability. LaSrMn or LaSrFeCo are typical materials. Advantageously, the positions A and B are partly replaced by elements such as Cr, Pr, Ba, Ca, Ni, Cu, Ti, Y, Zr or Ce, in order to improve the performance of the cathode in this manner. The addition of noble metals further improves the catalytic activity in relation to the reduction of oxygen.

### EXAMPLE 1

To begin with, 4.6 g of cerium (III) nitrate and 1.9 g of gadolinium (III) nitrate are dissolved in 50 mL of absolute ethanol. Subsequently, 1 g of carbon black or soot (commercially obtainable as “Black Pearls 2000 from the Cabot Corp.), with an average diameter of 12 nm, is added. The mixture is homogenized in a glass flask in an ultrasonic bath for two hours. Subsequently, the very viscous mixture is stirred or mixed at a temperature of 60° C. for 24 hours. Thereupon, evaporation is permitted.

The black solid, so obtained, is treated subsequently for half a day in a furnace at a temperature of 175° C. Thereupon, the temperature is increased at 2° per minute to 550° C. and the solid is calcined for six hours at 550° C.

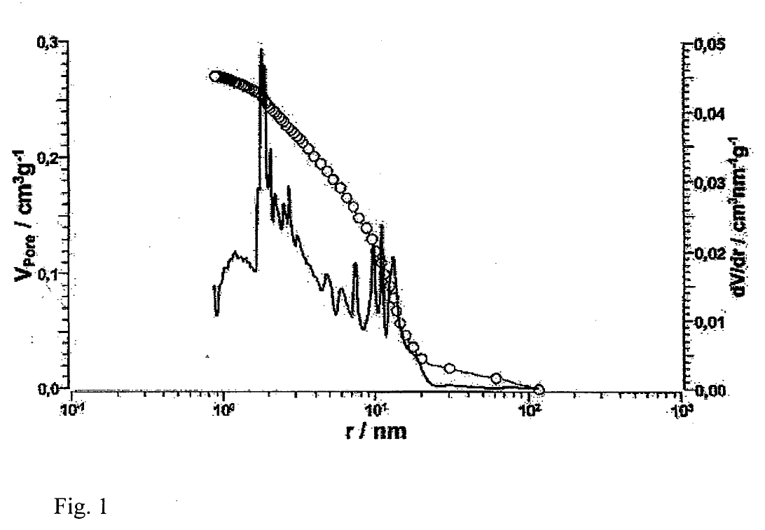

The bright yellow powder, formed in this manner, is ground in a mortar. A material with a surface area of 90 m² per gram and a pore distribution, which is reproduced in FIG. 1, is obtained in this way. The curve, formed by the circles, is assigned to the left axis. This curve shows the adsorbed volume of nitrogen per gram for each pore size fraction. The continuous line is assigned to the right axis. This line describes the amount of pores a function of the pore size.

Approximately 1% by weight of palladium is added by ion exchange to the bright yellow powder in the following manner. The bright yellow powder (0.85 g) is exposed to an aqueous solution of palladium for 20 hours at 90° C. The aqueous solution comprises 0.0002% by weight of palladium (II) nitrate. Subsequently, the resulting solid is washed, dried and ground for two days in a ball mill.

The powder (1 g), so obtained, as well as a LaO_{0.65}Sr_{0.3}MnO₃ Perovskite material, obtained by spray drying, are ground together. A composite powder is obtained and mixed with 2 g of a solution of ethyl cellulose in terpineol (6% by weight) and ground in a 3 roller mill, until a homogeneous paste is obtained. A thin film of this paste, with an initial thickness of, for example, 73 μm, is applied on the upper side of an electrolyte, consisting, for example, of a sintered, flat 8YSZ, for example, by screen printing. The film is dried for 8 hours at 60° C. and, together with the electrolyte and advantageously with the thereon applied anode material, is calcined for three hours at 920° C. To achieve the end temperature, the temperature is raised by 3° C. per minute and finally reduced once again at the rate of 5° C. per minute.

For example, an 8YSZ/NiO cement with a function layer of 8YSZ/NiO is provided as anode substrate. The electrolyte layer is then on the anode substrate and the cathode material, produced pursuant to the invention, is then on the electrolyte layer.

### EXAMPLE 2

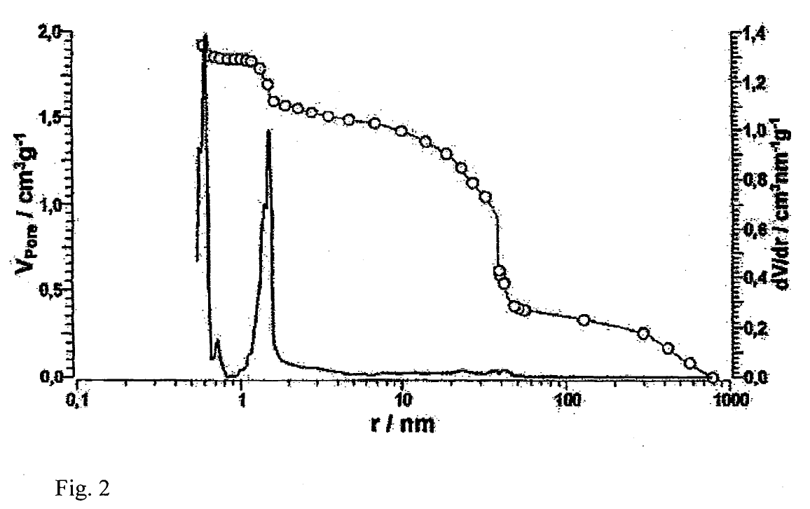

Zirconium chloride (2 g), 0.15 g of yttrium chloride and 2 g of the surfactant Brij 76 (a surfactant, which can be obtained commercially under this name) are dissolved in water. A clear solution is obtained by stirring. Subsequently, 50 mL of a suitable aqueous solution (25% by weight) is added, in order to precipitate the zirconium and yttrium contained in the solution. ZrOCl2 and Ycl3 hydrate, dissolved in distilled water, are suitable as solution, the proportion of chloride salt finally being 2% by weight and the molar ratio of Zr to Y being 11.5. The suspension, so obtained, is stirred for 5 hours at 50° and subsequently for 3 days at 80° in a flask and then filtered, a white powder being obtained. Subsequently, a white powder is obtained by filtration and washed with water and ethanol. The washed, white powder is then dried in a furnace at 100° C. for ten hours, after which the temperature is raised by 2° C. per minute until it reaches 500° C. The dried white powder is calcined for two hours at 500° C. The YSZ1 powder, so obtained, is ground in a mortar. The ground YSZ1 powder has a surface area of 650 m²/gram and the bimodal distribution of pore sizes, with an average pore size of 12 Å and 32 Å, is shown in FIG. 2. The curve, formed by circles, is assigned to the left axis. This curve shows the absorbed volume of nitrogen per gram for each pore fraction. The continuous line is assigned to the right axis. This describes the number of pores per pore size.

Subsequently, 1% by weight of palladium is incorporated by ion exchange into the YSZ1. For this purpose, 0.85 g of YSZ1 is added to an aqueous solution of palladium (0.0002% by weight of palladium (II) nitrate) and the ion exchange is carried out for 20 hours at 90° C. The solid YSZ2, so obtained, is dried and ground for two days in a ball mill.

Subsequently, a dot matrix printing paste is prepared in the following way from the YSZ2. YSZ2 (1 g), as well as LaO_{0.65}Sr_{0.3}MnO₃ Perovskite material, obtained by spray drying, are ground together, a composite powder being obtained. This composite powder is mixed with 2 g of a solution of ethyl cellulose in terpineol (6% by weight) and ground in a 3-roller mill, until a homogeneous paste is obtained. A thin film of this paste, with an initial thickness of, for example, 73 μm, is applied, for example, by screen printing, on the upper side of an electrolyte, such as a sintered, flat electrolyte consisting of 8YSZ. The film is dried for eight hours at 60° C. and then calcined for three hours at 920° C. together with the electrolyte, consisting, for example, of 8YSZ, and advantageously, in addition, with anode material, mounted thereon and consisting, for example, of 8YSZ/NiO. The temperature is increased by 3° C. per minute in order to reach the final temperature and finally decreased at the rate of 5° C. per minute. A fuel cell results.

The surface, which is finally obtained for the cathode, is adjusted by varying the respective duration and temperature of the treatment within the range is given above.

1-9. (canceled)

10. A method for producing a cathode comprising:
preparing a mixture of salts, a solvent for the salts and a filler,
preparing particles from the mixture, comprising the filler and materials dissolved in the solution,
removing the filler from the particles, and
applying the porous particles on a sintered electrolyte layer and thermally treating to provide a cathode.

11. The method of claim 10, wherein
the salts have metallic components and carbon particles or a surface active material is provided for preparing the filler,
the particles are obtained from the mixture by a thermal treatment or by precipitation,
the filler is removed from the particles by combustion,
the sintered electrolyte, on which the porous particles are applied, is treated thermally under a gas at a temperature between 650° and 1200° C.

12. The method of claim 10, wherein the solvent is selected from the group consisting of alcohol, polyalcohol, water and ethanol.

13. The method of claim 10, wherein the salts are selected from the group consisting of alkoxide, citrate, acetate, halide and nitrate.

14. A cathode for a high-temperature fuel cell, comprising a layer of porous particles applied on a sintered electrolyte, the layer having a surface area of 15 to 900 m² per gram and the average size of the porous particles not exceeding 30 nm.

15. The cathode of claim 14, comprising:
cerium oxide doped with at least one member selected from the group consisting of Gd, Sm, Pr, Nd, Er, Yb, and Dy, and/or
zirconium oxide doped with at least one member selected from the group consisting of Y, Sc, Ca, Mg, Al, Er, Yb, Gd, and elements selected from the group consisting of the series Eu to Dy, and/or
mixed oxides with elements selected from the group consisting of La, Sr, Mn, Fe, Co, Cr, Pr, Ba, Ca, Ni, Cu, Ti, Y and elements from the series Zr to Ce.

16. The cathode of claim 14 having a structure selected from the group consisting of Perovskite structure, calcium fluoride structure, pyrochloride structure, Runddlesden-Popper oxide structure and a bronze structure.

17. The cathode of claim 14, wherein said cathode comprises a noble metal.

18. The cathode of claim 14 having an average pore size between 0.5 and 8 nm.

19. The cathode of claim 14, having a bimodal distribution of pore sizes.

20. The cathode of claim 17, wherein said noble metal comprises at least one selected from the group consisting of Pt, Pd, Rh, Au, Ru, Re, Ag, and Ir.
